(19) United States
(12) Patent Application Publication
(10) Pub. No.: US 2007/0042166 A1
(43) Pub. Date: Feb. 22, 2007

(54) Tape substrate having reinforcement layer for tape packages

(75) Inventors: Ye-Chung Chung, Suwon-si (KR); Jae-Cheon Doh, Dujeong-dong cheonan-si (KR)

Correspondence Address: HARNESS, DICKEY & PIERCE, P.L.C., P.O. BOX 8910, RESTON, VA, 20195, US

(73) Assignee: Samsung Electronics Co., Ltd.

(21) Appl. No.: 11/372,115

(22) Filed: Mar. 10, 2006

(30) Foreign Application Priority Data
Aug. 22, 2005 (KR) 2005-76741

(51) Int. Cl. B32B 15/00

(52) U.S. Cl. 428/209

(57) ABSTRACT

The following invention is directed to a tape substrate having a reinforcement layer for tape packages and a method of fabricating the same. In an example embodiment, a tape substrate for tape packages may include a base film, a circuit pattern formed on the base film, and at least one reinforcement layer formed over a surface of the base film. The base film may have sprocket holes formed at regular intervals in the surface of the base film along at least one outer edge of the base film. The at least one reinforcement layer may have guide holes corresponding to the sprocket holes of the base film that are larger than the sprocket holes. The example embodiment may also include at least one reinforcement being set back from the outer edge of the base film.

### PRIORITY STATEMENT

This U.S. non-provisional application claims benefit of priority under 35 U.S.C.§119 from Korean Patent Application No. 2005-76741, filed on Aug. 22, 2005, the entire contents of which are incorporated herein by reference.

### BACKGROUND OF THE INVENTION

1. Field of the Invention

The present invention relates generally to a tape substrate having a reinforcement layer for tape packages and, more particularly, to a tape substrate having a reinforcement layer in the lower surface thereof having sprocket holes for tape packages.

2. Description of the Related Art

Recent years have seen a steady growth in the demand for flat panel display devices such as liquid crystal displays (LCDs) for mobile phones, thin film transistor (TFT) LCDs for computers, and home plasma display panels (PDPs). There has also been a corresponding growth in demand for tape packages, which are utilized as components of drive integrated circuit (drive IC) chips for these flat panel display devices. With trends towards lighter and thinner flat panel display devices, circuit patterns of a finer-linewidth are needed for the tape packages.

The tape packages are semiconductor packages utilizing tape substrates. They are broadly classified into tape carrier packages (TCPs) and chip on film (COF) packages. In a TCP, a semiconductor chip is mounted on a tape substrate by connecting the semiconductor chip to inner leads of the tape substrate exposed through a window in the tape substrate, using inner lead bonding (ILB). In a COF package, a semiconductor chip is mounted on a window-free tape substrate through flip chip bonding.

In a manufacturing process of tape packages, a tape substrate is moved from one reel to another reel. This reel-to-reel movement of the tape substrate is performed using sprocket holes formed at regular intervals along both edges of the tape substrate.

Because a tensile force of predetermined strength is applied to the tape substrate during the reel-to-reel movement, the tape substrate may be warped or torn at sites where sprocket holes are formed, and thereby become vulnerable to stress.

A solution to this problem is to form a reinforcement layer of stainless steel in the lower surface of a base film having sprocket holes. The reinforcement layer has guide holes with the same size as that of the sprocket holes, and the outer side surface of the reinforcement layer and that of the base film are coplanar.

During manufacturing processes such as assembly of a tape substrate or mounting of a tape package on a panel, mechanical contact may occur between the tape substrate and a manufacturing facility. Such mechanical contact usually occurs around each sprocket hole where a guide pin is inserted, and at the two outer side surfaces of the tape substrate.

However, because a guide hole formed in the reinforcement layer has the same size as a sprocket hole, the guide pin that is inserted into the sprocket hole may mechanically contact with the reinforcement layer during transportation or alignment of the tape substrate. Metal debris detached from the reinforcement layer due to the mechanical contact may be moved by the guide pin, projected towards the upper surface of the tape substrate onto a circuit pattern of the tape substrate become attached to the circuit pattern, and cause the circuit pattern on the tape substrate to short circuit.

Moreover, because the outer side surface of the reinforcement layer and the base film are coplanar, metal debris may be produced due to mechanical contact between the outer side surfaces of the tape substrate and the manufacturing facility. If this metal debris adheres to a circuit pattern of the tape substrate, the circuit pattern may short circuit.

In addition, while the reinforcement layer may prevent deformation of the tape substrate, the restorability of the reinforcement layer against an external force is lower than that of the flexible tape substrate. Thus, once the reinforcement layer is deformed due to the external force, it is more difficult to restore the reinforcement layer to an original state than to restore the flexible tape substrate to an original state. In the conventional tape substrate, an external force due to mechanical contact between the tape substrate and manufacturing facility is directly transferred to the reinforcement layer. Thus, an external force exceeding a certain level of strength may deform the reinforcement layer, and result in deformation of the tape substrate.

### SUMMARY OF THE INVENTION

The following invention is directed to a tape substrate having a reinforcement layer for tape packages and a method of fabricating the same.

In an example embodiment, a tape substrate for tape packages may include a base film, a circuit pattern formed on the base film, and at least one reinforcement layer formed over a surface of the base film. The base film may have sprocket holes formed at regular intervals in the surface of the base film along at least one outer edge of the base film. The at least one reinforcement layer may have guide holes corresponding to the sprocket holes of the base film that are larger than the sprocket holes.

In the example embodiment, the at least one reinforcement layer may be formed on the lower surface of the base film. Furthermore, the at least one reinforcement layer may be more rigid than the base film, and may be made of a metallic material, for example, copper or stainless steel.

In another example embodiment, the tape substrate may have at least one reinforcement layer formed over at least one outer edge of the surface of the base film, the at least one reinforcement layer being set back from the outer edge of the base film. In this example embodiment, the guide holes may be the same size or smaller than the sprocket holes of the base film.

In yet another example embodiment, the at least one reinforcement layer may be set back from the outer edge of the base film, along with the sprocket holes are formed, and have guide holes that are larger than the corresponding sprocket holes.

### BRIEF DESCRIPTION OF THE DRAWINGS

FIG. 1 is a perspective view showing a tape substrate having a reinforcement layer for tape packages according to a first embodiment of the present invention.

FIG. 2 is a sectional view showing the tape substrate taken along the line II-II in FIG. 1.

FIG. 3 is a partial sectional view showing insertion of a guide pin into the tape substrate of FIG. 2.

FIG. 4 is a sectional view showing a tape substrate having a reinforcement layer for tape packages according to a second embodiment of the present invention.

FIG. 5 is a sectional view showing a tape substrate having a reinforcement layer for tape packages according to a third embodiment of the present invention.

### DETAILED DESCRIPTION OF EXAMPLE EMBODIMENTS

Hereinafter, example embodiments of the present invention will be described in detail with reference to the accompanying drawings. This invention may, however, be embodied in many different forms and should not be construed as limited to the example embodiments set forth herein. Rather, the disclosed embodiments are provided so that this disclosure will be thorough and complete, and will fully convey the scope of the invention to those skilled in the art. The principles and features of this invention may be employed in varied and numerous embodiments without departing from the scope of the invention.

In this disclosure, well-known structures and processes are not described or illustrated in detail to avoid obscuring the present invention. Furthermore, the figures are not drawn to scale in the drawings. Rather, for simplicity and clarity of illustration, the dimensions of some of the elements are exaggerated relative to other elements.

### First Embodiment

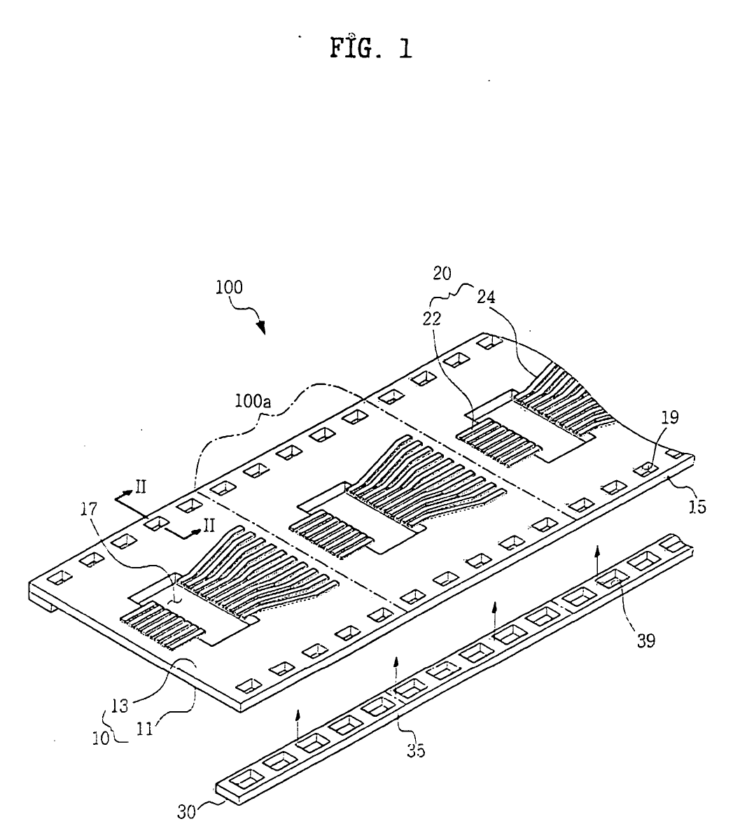

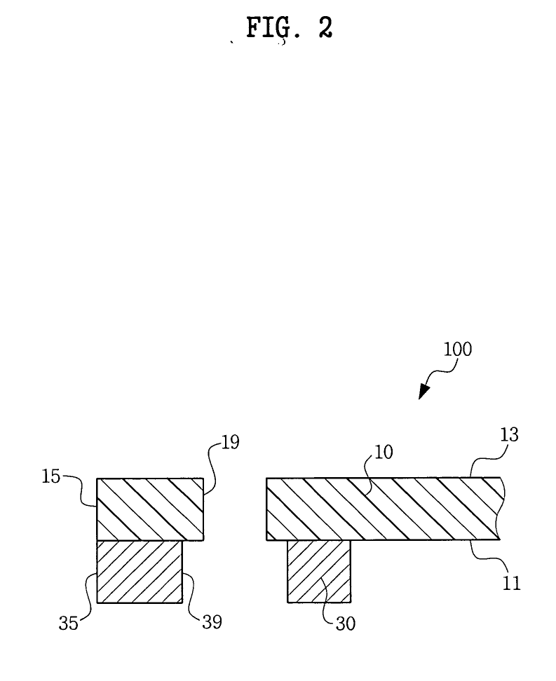

Referring to FIGS. 1 to 3, a tape substrate 100 according to a first embodiment is a TCP tape substrate including a semiconductor chip mounting window 17. The tape substrate 100 is in the form of a strip including a plurality of consecutive unit tape substrates 100a, each for manufacturing a TCP. The tape substrate 100 comprises a base film 10 and a reinforcement layer 30. The base film 10 has a circuit pattern 20 formed on an upper surface 13 of the base film 10, and the reinforcement layer 30 is formed along both edges of a lower surface 11 of the base film 10.

The windows 17 on which semiconductor chips are mounted are formed on a central area of the base film 10, and sprocket holes 19 are formed at regular intervals in a longitudinal direction along both edges of the base film 10. The base film 10 is made of insulating synthetic resin such as polyimide resin, acrylic resin, polyether nitrile resin, polyether sulfone resin, polyethylene terephthalate resin, polyethylene naphthalate resin, and polyvinyl chloride resin. Preferably, the base film 10 is made of polyimide resin. In this case, the base film 10 has a thickness of 25 to 38 μm.

To form the circuit pattern 20, a copper (Cu) foil, for example, is attached on the upper surface 13 of the base film 10 and then patterned using a photolithographic process. The ends of the circuit pattern 20 that are exposed through the window 17 are inner lead bonded (ILB) to a semiconductor chip, and the other ends extend from the window 17 towards both edges of the upper surface 13 on which the sprocket holes 19 are formed. The circuit pattern 20 has input circuit patterns 22 extending from the window 17 to one side, and output circuit patterns 24 extending to another side; whereby the number of the output circuit patterns 24 is greater than that of the input circuit patterns 22. The circuit pattern 20 is made of materials having good electric conductivity such as copper (Cu), nickel (Ni), solder, or an alloy of these. The circuit pattern 20 has a thickness of about 8 μm. Although not shown, the circuit pattern 20, except two ends thereof, is protected by a protective layer made of, for example, solder resist. Although it is illustrated that the circuit pattern 20 is formed only on the upper surface 13 of the base film 10 in the present embodiment, other circuit patterns may be formed on the lower surface 11 of the base film 10.

The reinforcement layer 30 made of a metallic material is formed along both edges of the lower surface 11 of the base film 10. The reinforcement layer 30 has guide holes 39 corresponding to the sprocket holes 19. The reinforcement layer 30 is made of copper or stainless steel, and has a thickness of 20 to 30 μm. A side surface 35 of the reinforcement layer 30 corresponds to and aligns with a side surface 15 of the base film 10.

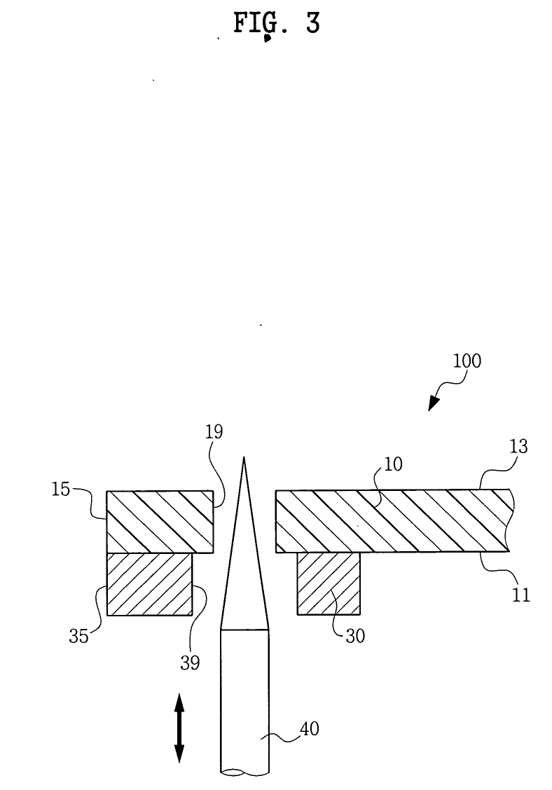

In particular, each guide hole 39 formed in the reinforcement layer 30 is larger than the corresponding sprocket hole 19. As shown in FIG. 3, this is to prevent a guide pin 40, which is inserted into the sprocket hole 19 in a manufacturing process, from mechanically contacting with the reinforcement layer 30. Because the guide hole 39 is formed larger than the corresponding sprocket hole 19, the guide pin 40 does not first mechanically contact the inside or periphery of the guide hole 39 in the reinforcement layer 30 when the guide pin 40 is inserted into the sprocket hole 19.

Consequently, generation of metal debris due to mechanical contact between the guide pin 40 and the periphery of the guide hole 39 of the reinforcement layer 30 may be reduced, thus lowering the likelihood of a short circuit due to the metal debris. In addition, because mechanical contact between the guide pin 40 and the reinforcement layer 30 is reduced, deformation of the reinforcement layer 30 caused by the guide pin 40 may be reduced.

More specifically, if mechanical contact occurs when the guide pin 40 is inserted into the sprocket hole 19, the guide pin 40 contacts first with the sprocket hole 19, which is smaller than the corresponding guide hole 39. The base film 10 having the sprocket hole 19 is flexible. When stress caused by the guide pin 40 is applied to the tape substrate 100, the base film 10 may be deformed while absorbing the stress, but can return to an original state after detachment of the guide pin 40. Further, the reinforcement layer 30 formed around sprocket holes 19 enhances the strength of the edge area of the base film 10 having the sprocket holes 19. Thus, the base film 10 is not warped or torn even in the case of mechanical contact between the guide pin 40 and the sprocket holes 19. Accordingly, a short circuit and deformation of the tape substrate 100 due to mechanical contact between the guide pin 40 and the tape substrate 100 are reduced.

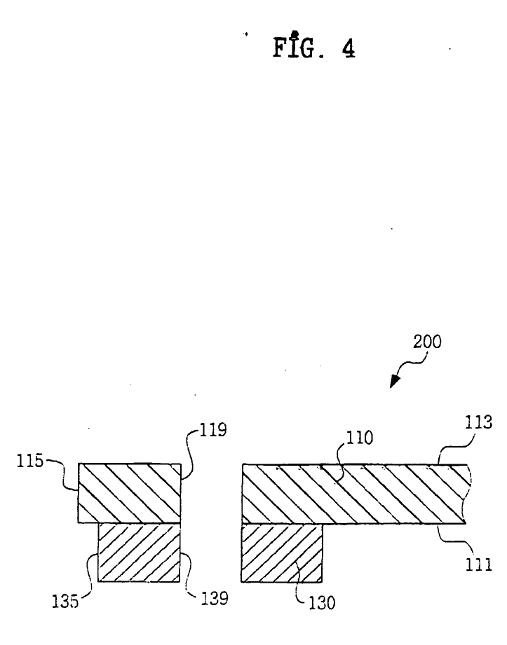

In the first embodiment, the guide hole is formed larger than the corresponding sprocket hole to prevent mechanical contact between the guide pin and the reinforcement layer. In the present embodiment, as shown in FIG. 4, to prevent mechanical contact between a manufacturing facility and a reinforcement layer 130 formed along both edges of a tape substrate 200, the reinforcement layer 130 is formed such that the outer side surface 135 thereof is set back from the corresponding outer side surface 115 of a base film 110.

### Second Embodiment

Referring to FIG. 4, the tape substrate 200 according to the second embodiment includes the reinforcement layer 130 formed along both edges of the lower surface 111 of the base film 110. While guide holes 139 formed in the reinforcement layer 130 have the same size as corresponding sprocket holes 119 of the base film 110, the outer side surface 135 of the reinforcement layer 130 is formed set back from the corresponding outer side surface 115 of the base film 110.

Consequently, mechanical contact between the tape substrate 200 and a manufacturing facility occurs at the two outer side surfaces 115 of the base film 110 in a manufacturing process. For example, while a tape substrate 200 is guided and transported along a transportation rail, mechanical contact between the transportation rail and the outer side surfaces 115 of the tape substrate 200 may occur. Because the reinforcement layer 130 is formed set back from the outer side surface 115 of the base film 110, mechanical contact occurs first between the transportation rail and the base film 110, and mechanical contact between the transportation rail and the reinforcement layer 130 may be avoided. Because the base film 110 is flexible, the base film 110 is deformed while absorbing stress due to the mechanical contact, and returns to an original state after removal of the mechanical contact.

Accordingly, because mechanical contact between the outer side surface 135 of the reinforcement layer 130 and a manufacturing facility can be avoided, generation of metal debris can be prevented and the likelihood of a short circuit due to the metal debris can also be reduced. In addition, deformation of the reinforcement layer 130 due to the mechanical contact can be avoided.

### Third Embodiment

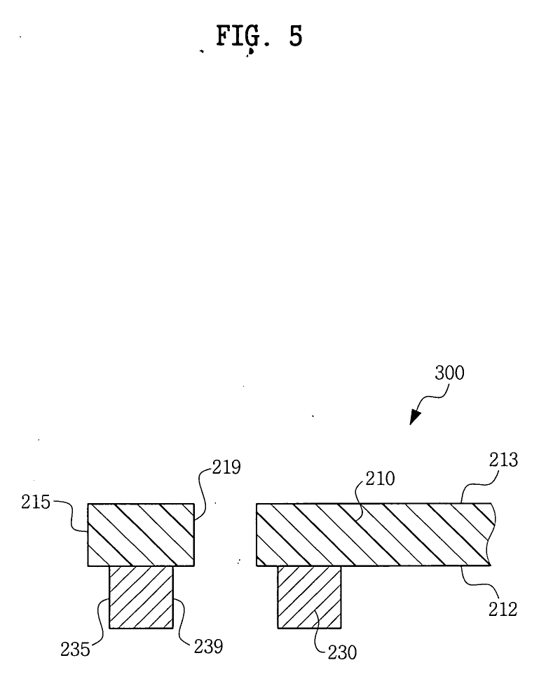

In the third embodiment as shown in FIG. 5, the configurations of the reinforcement layers according to the first and second embodiments are combined to form the configuration of a reinforcement layer of a tape substrate 300.

In the reinforcement layer 230 according to the third embodiment, a guide hole 239 is formed larger than the corresponding sprocket hole 219 as in the case of the first embodiment, and the outer side surface 235 of the reinforcement layer 230 is formed set back from the corresponding outer side surface 215 of the base film 210 as in the case of the second embodiment.

For this reason, even though a manufacturing facility mechanically contacts with the tape substrate 300, the manufacturing facility is effectively prevented from mechanically contacting with the reinforcement layer 230. Furthermore, the mechanical contact between the guide pin (40 of FIG. 3) and an inside of the guide hole 239 is reduced because the guide hole 239 is formed larger than the corresponding sprocket hole 219. In addition, a manufacturing facility is less likely to have mechanical contact with the outer side surface 235 of the reinforcement layer 230, because the outer side surface 235 of the reinforcement layer 230 is formed set back from the corresponding outer side surface 215 of the base film 210.

As apparent from the above description, the present invention provides a tape substrate having a reinforcement layer. Guide holes larger than corresponding sprocket holes are formed in the reinforcement layer attached to both edges of the lower surface of a base film. Thus, even though a guide pin inserted from under the tape substrate into one of the sprocket holes mechanically contacts with the tape substrate, the guide pin contacts first with the base film having the sprocket holes, and mechanical contact between the guide pin and the reinforcement layer is reduced.

In addition, the outer side surface of the reinforcement layer is formed set back from the corresponding outer side surface of the base film. Thus, even though a transportation rail mechanically contacts with outer side surfaces of the tape substrate during a manufacturing process, the transportation rail contacts first with the outer side surfaces of the base film, and mechanical contact between the transportation rail and the reinforcement layer is reduced.

Accordingly, when a manufacturing facility mechanically contacts with the tape substrate during the manufacturing process, the base film absorbs stress due to the mechanical contact and reduces the mechanical contact between the manufacturing facility and the reinforcement layer. Thus, generation of metal debris can be avoided and a short circuit due to the metal debris can also be avoided. In addition, deformation of the reinforcement layer can be minimized.

While example embodiments of the invention have been shown and described in this specification, it will be understood by those skilled in the art that various changes or modification of the embodiments are possible without departing from the spirit of the invention. For example, while square guide holes have been formed corresponding to square sprocket holes in the embodiments, the guide holes and sprocket holes may be formed to have other forms such as a polygon having more than four corners or an oval. Further, the reinforcement layer is not limited to being formed only on the lower layer, but may, for example, be attached to the upper layer. Also, while the tape substrate is described in relation to a TCP in the embodiments, the tape substrate may also be applicable to a COF package.

What is claimed is:

1. A tape substrate for tape packages, comprising:
a base film having sprocket holes formed at regular intervals in a surface of the base film and along at least one outer edge of the base film;
a circuit pattern formed on the base film; and
at least one reinforcement layer formed over the surface of the base film, the reinforcement layer having guide holes corresponding to the sprocket holes, the guide holes being larger than the sprocket holes.

2. The tape substrate of claim 1, wherein an outer edge of the reinforcement layer is set back from the outer edge of the base film.

3. The tape substrate of claim 1, wherein the reinforcement layer is made of a metallic material.

4. The tape substrate of claim 3, wherein the reinforcement layer is made of copper (Cu) or stainless steel.

5. The tape substrate of claim 1, wherein the reinforcement layer has a thickness ranging from 20 to 30 μm.

6. The tape substrate of claim 1, wherein the at least one reinforcement layer is more rigid than the base film.

7. The tape substrate of claim 1, wherein the at least one reinforcement layer is formed on a lower surface of the base film.

8. The tape substrate of claim 1, wherein,
the base film includes sprocket holes formed along first and second outer edges thereof; and
first and second reinforcement layers are formed on the surface of the base film such that the guide holes of the first reinforcement layer correspond to the sprocket holes along the first outer edge and the guide holes of the second reinforcement layer correspond to the sprocket holes of the second outer edge.

9. A tape substrate for tape packages, comprising:
a base film having sprocket holes formed at regular intervals in a surface of the base film and along at least one outer edge of the base film;
a circuit pattern formed on the base film; and
at least one reinforcement layer formed over the surface of the base film, the at least one reinforcement layer having guide holes corresponding to the sprocket holes, and an outer edge of the at least one reinforcement layer being set back from the outer edge of the base film.

10. The tape substrate of claim 9, wherein the reinforcement layer is made of a metallic material.

11. The tape substrate of claim 10, wherein the reinforcement layer is made of copper (Cu) or stainless steel.

12. The tape substrate of claim 9, wherein the reinforcement layer has a thickness ranging from 20 to 30 μm.

13. The tape substrate of claim 9, wherein the at least one reinforcement layer is more rigid than the base film.

14. The tape substrate of claim 9, wherein the at least one reinforcement layer is formed on a lower surface of the base film.

15. The tape substrate of claim 9, wherein,
the base film includes sprocket holes formed along first and second outer edges thereof; and
first and second reinforcement layers are formed on the surface of the base film such that the guide holes of the first reinforcement layer correspond to the sprocket holes along the first outer edge and the guide holes of the second reinforcement layer correspond to the sprocket holes of the second outer edge.

16. A method for reinforcing a tape carrier package, the tape carrier package substrate having sprocket holes formed at regular intervals in a surface of a base film and along at least one outer edge of the base film, and a circuit pattern formed on the base film, the method comprising:
forming at least one reinforcement layer over the surface of the base film, the at least one reinforcement layer having guide holes corresponding to the sprocket holes, and the guide holes being larger than the sprocket holes

17. The method of claim 16, wherein an outer edge of the reinforcement layer is set back from the outer edge of the base film.

18. The method of claim 16, wherein the forming step includes forming the at least one reinforcement layer on a lower surface of the base film.

19. A method for reinforcing a tape carrier package, the tape carrier package substrate having sprocket holes formed at regular intervals in a surface of a base film and along at least one outer edge of the base film, and a circuit pattern formed on the base film, the method comprising:
forming at least one reinforcement layer over the surface of the base film, the at least one reinforcement layer having guide holes corresponding to the sprocket holes, and an outer edge of the at least one reinforcement layer being set back from the outer edge of the base film

20. The method 19, wherein the forming step includes forming the at least one reinforcement layer on a lower surface of the base film.
